(19) United States
(12) Patent Application Publication
(10) Pub. No.: US 2026/0362130 A1
(43) Pub. Date: Nov. 12, 2026

(54) SCREEN SHARING AND INTER-DEVICE COMMUNICATIONS SYSTEM

(71) Applicant: Ripple Two, LLC, Charleston, SC (US)

(72) Inventors: Edwin Whitner SLAGSVOL, Charleston, SC (US); Joseph Broms, Charleston, SC (US); Philip Armand Dutrisac, Charleston, SC (US)

(73) Assignee: Ripple Two, LLC, Charleston, SC (US)

(21) Appl. No.: 19/100,224

(22) PCT Filed: Aug. 2, 2023
(86) PCT No.: PCT/US2023/071500

§ 371 Date: Jan. 31, 2025

Related U.S. Application Data
(60) Provisional application No. 63/370,153, filed on Aug. 2, 2022.

(51) Int. Cl. H04W 12/0431; G06F 3/14; H04R 1/10; H04W 84/22

(52) U.S. Cl. CPC H04W 12/0431; G06F 3/1454; H04R 1/10; H04R 2201/107; H04W 84/22

(57) ABSTRACT

A communication system includes a plurality of signal connected mobile communication hubs. Each of the mobile communication hubs includes a controller in signal communication with each of a first mechanical communication device establishing a direct wired connection with a mobile device having a display screen, a first wireless communication device configured to utilize a first wireless communication process, and a second wireless communication device configured to utilize a second wireless communication process different from the first wireless communication process.

### CROSS-REFERENCE TO RELATED APPLICATION

This patent application claims priority to U.S. Provisional Patent Application Ser. No. 63/370,153, filed on Aug. 2, 2022, the entire disclosure of which is hereby incorporated herein by reference.

### FIELD OF THE INVENTION

The present invention is generally directed to a communications system, and more particularly, to a communications system utilizing wireless and/or direct communications methods for communicating between a plurality of associated communication devices.

### BACKGROUND

Military personnel often encounter disadvantageous conditions that render communication difficult in certain circumstances, such as when traveling via an especially loud vehicle. It is also common for radio traffic to become congested in such conditions. Each of these concerns typically results in the need to create a larger than desired signature via broadcasting over a radio, to use hard-wired intra-vehicle communication systems, or simply to yell at a high volume to ensure that comments can be heard over the ambient noise. The creation of a radio broadcast is undesirable as this broadcast can be intercepted and is easily detectable, and the user may still need to transmit and receive voice, data, and video. Specifically, it can be especially undesirable to emit a radio broadcast at the frequencies or with the power typical of a military utilized radio. The intra-vehicle communications system is extremely limited as only those users within the vehicle can utilize the system. Yelling is also not an effective solution, and may further present issues wherein others in communication with those yelling, such as over radio broadcasts, are also subjected to the loud volume.

There accordingly exists a need for a communication system capable of presenting information in a secure and easily perceptible manner when faced with such undesirable conditions. Similar concerns may also be addressed in non-military fields such as civilian law enforcement, search and rescue deployment, and other such team based activities that are subject to loud or disorienting conditions.

It is also common for existing communication systems that rely upon some form of radio frequency broadcast to utilize some form of encrypted key or shared secret to prevent others from interpreting the broadcast signals. The use of a such a key or shared secret typically requires all devices associated with such an endeavor to be reprogrammed (re-keyed) to include knowledge of the key or shared secret prior to initiation of the endeavor, such as requiring physical access to each associated device for performing all necessary forms of authentication and encryption. Re-keying in the field, especially during a mission, is not typical in order to avoid potential errors that may arise when inconsistencies are present between different devices and also to prevent the risk of the enemy becoming aware of the key or shared secret during the attempt to re-key the associated devices.

There accordingly exists a need for a communication system that can securely and efficiently facilitate the re-keying of all associated communication devices during a mission or other planned activity, such as during a battle or other chaotic situation.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing a novel communication system. The communication system includes a plurality of signal connected mobile communication hubs. Each of the mobile communication hubs includes a controller in signal communication with each of a first mechanical communication device establishing a direct wired connection with a mobile device having a display screen, a first wireless communication device configured to utilize a first wireless communication process, and a second wireless communication device configured to utilize a second wireless communication process different from the first wireless communication process.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is schematic representation of a mobile communication hub according to an embodiment of the present invention;

FIG. 2 is a schematic representation of a communication system including a plurality of the mobile communication hubs of FIG. 1;

FIG. 3 is a schematic representation of the transfer of data between first and second mobile communication hubs utilizing two different wireless communication processes;

FIG. 4 is a front perspective view of a casing of the mobile communication hub of FIG. 1 according to an embodiment of the present invention;

FIG. 5 is a right-side elevational view of the casing of FIG. 4; and

FIG. 6 is a left-side elevational view of the casing of FIG. 4.

### DETAILED DESCRIPTION OF EMBODIMENTS OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom.

Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures.

Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present invention relates to a communication system 10 utilizing a plurality of mobile communication hubs 12. Each of the mobile communication hubs 12 may be referred to simply as a hub 12 hereinafter for brevity. Each of the hubs 12 may be configured for selective signal communication with at least one respective external device, which may be an audio/visual (A/V) device 14. The A/V device 14 may refer to a purely audio-based device having purely audio capabilities, a purely visual or display-based device having visual or video playback capabilities, or a combined audiovisual device having both audio and visual capabilities, as desired. Each of the A/V devices 14 may be utilized to visually or audibly access data by a user that has been transferred to or from one of the hubs 12 according to the methods disclosed herein. The hub 12 may accordingly be devoid of a dedicated display screen, camera, microphone, speaker, or the like, and may instead rely upon connections to the external devices, such as the A/V devices 14, for allowing such interaction with the data transferred among and between the hubs 12 by the associated user.

In some embodiments, one of the A/V devices 14 in signal communication with one of the respective hubs 12 may be a mobile device or smart device 15, which may refer to, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. The user device may be configured to execute any suitable operating system, including Linux, UNIX, Windows, macOS, iOS, Android and any other known operating system used on personal computers, central computing systems, phones, tablets, and other such devices.

The mobile device 15 may include components such as, at least one of each of a processing device and a memory device for processing use, such as random access memory (RAM), and read-only memory (ROM). The mobile device 15 may further include a storage device including at least one of a non-transitory storage medium, such as a microdrive, for long-term, intermediate-term, and short-term storage of computer-readable instructions for execution by the processing device. For example, the instructions can include instructions for an operating system and various applications or programs. The storage device can store various other data items, which can include, as non-limiting examples, cached data, user files such as those for pictures, audio, and/or video recordings, files downloaded or received from other devices, and other data items preferred by the user or required or related to any or all of the applications or programs. The memory device may be operatively coupled to the processing device. As used herein, memory includes any computer readable medium to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory can additionally or alternatively include an electrically erasable programmable read-only memory (EEPROM), flash memory or the like. The memory device and storage device can store any of a number of applications which comprise computer-executable instructions and code executed by the processing device to implement the functions of the mobile device 15 as described herein.

The mobile device 15 may include a user interface for forming an input and output system, referring to, including, or operatively coupled with, user input devices and user output devices, which are operatively coupled to the processing device of the mobile device 15. The user output devices include a display (e.g., a liquid crystal display or the like), which can be, as a non-limiting example, a touch screen of the mobile device 15, which serves both as an output device, by providing graphical and text indicia and presentations for viewing by a user, and as an input device, by providing virtual buttons, selectable options, a virtual keyboard, and other indicia or interactive graphics that, when touched, control the mobile device 15 by user action. The user output devices in addition to the display may optionally include a speaker or other audio device. The user input devices, which allow the mobile device 15 to receive data and actions such as button manipulations and touches from a user, may include any of a number of devices allowing the mobile device 15 to receive data from a user, such as a keypad, keyboard, touch-screen, touchpad, microphone, mouse, joystick, stylus, other pointer device, button, soft key, and/or other input device(s). The user input devices may also include a camera, such as a digital camera.

Each of the hubs 12 includes a controller 20 (microcontroller) which may include at least one processing device 21 and at least one memory device 22. The processing device 21 may be configured to execute program instructions as stored to the memory device 22 for executing the functions of the controller 20 as described herein. The processing device 21 includes circuitry for implementing communication and/or logic functions of the hub 12 as described herein. For example, the processing device 21 may include a digital signal processor, a microprocessor, and various analog to digital converters, digital to analog converters, and/or other support circuits for carrying out the communications disclosed herein. The processing device 21 thus may also include the functionality to encode and interleave messages and data prior to modulation and transmission, as desired. The controller 20 may utilize an operating system that provides a runtime for C++applications along with any needed utilities to communicate with the devices external to the hub 12. The controller 20 may also be configured such that the hub 12 presents itself as a USB accessory (or other similar compatible connection type of form) for use with the corresponding mobile device 15 and other associated A/V devices 14.

The controller 20 may include a communication interface 23 in signal communication with the processing device 21, wherein the communication interface 23 may be provided for establishing the desired form or protocol of communication between the controller 20 and each of the A/V devices 14 in signal communication with the respective hub 12. The communication interface 23 may be associated and in signal communication with at least one external communication device of each respective hub 12, and each of the externally disposed A/V devices 14 may be in signal communication with the corresponding one of the mobile communication hubs 12 via a corresponding one of the external communication devices.

The external communication devices may include at least one mechanical communication device 40 for making a direct, wired, or docked connection with a communication component associated with one of the external devices configured for use with the hub 12, such as a corresponding adapter, connector, jack, port, or the like, as may be found at the end of a wired signal connection extending between the respective external device and hub 12 pairing. Each of the mechanical communication devices 40 may be associated with multiple different signal connections carried through the mechanical communication device 40, such as separate audio and visual-based signal connections.

The at least one external communication device may further include at least one wireless communication device 50. Each of the wireless communication devices 50 may include a transmitter and/or a receiver, or may be a dual transmitter/receiver (transceiver). Each of the distinct wireless communication devices 50 may be associated with a distinct wireless communication method or protocol, including being configured to receive or transmit wireless signals of different wavelengths or wavelength ranges.

In some embodiments, the at least one wireless communication device 50 may include at least two of the wireless communication devices 51, 52, which may be referred to hereinafter as the first or long-range wireless communication device 51 and the second or short-range wireless communication device 52. As the names suggest, the long-range wireless communication device 51 may include a relatively greater communication range for communicating with external devices, such as another one of the hubs 12 or mobile devices 15, than does the short-range wireless communication device 52. In some embodiments, the long-range wireless communication device 51 and the short-range wireless communication device 52 utilize different wireless communication structures or methods, including the use of different broadcast wavelengths, thereby creating the distinction in communication range based on the differences between the two different wireless communication structures or methods. In other embodiments, the short-range wireless communication device 52 may be associated with a relatively weaker broadcast or reception range than the long-range wireless communication device 51 while utilizing the same wireless communication structure or method, thereby establishing the distinction in communication range through the corresponding signal strength associated with each structure or method. It is also conceivable that the same wireless communication device 50 may be configured to provide the functions described herein with respect to each of the long-range and the short-range wireless communication devices 51, 52 via an adjustment of the corresponding wireless communication device 50, such as adjusting a broadcast range or a frequency range of the wireless communication device 50 between two different settings with each of the different and distinct settings corresponding to one of the different long-range or short-range wireless communication devices 51, 52.

The communication interface 23 may include digital signal processing circuitry and may provide two-way communications and data exchanges, for example wirelessly via one of the wireless communication devices 50 or via wired or docked communication by one of the mechanical communication devices 40. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via one of the wireless communication devices 50, which can be or include a radio-frequency transceiver, a Bluetooth device, Wi-Fi device, a Near-field communication device, and other transceivers, as explained in greater-detail hereinafter. In addition, GPS (Global Positioning System) may be included for navigation and location-related data exchanges, whether ingoing and/or outgoing. Communications may also or alternatively be conducted via one of the mechanical communication devices 40 for wired connections such by USB, Ethernet, and other physically connected modes of data transfer.

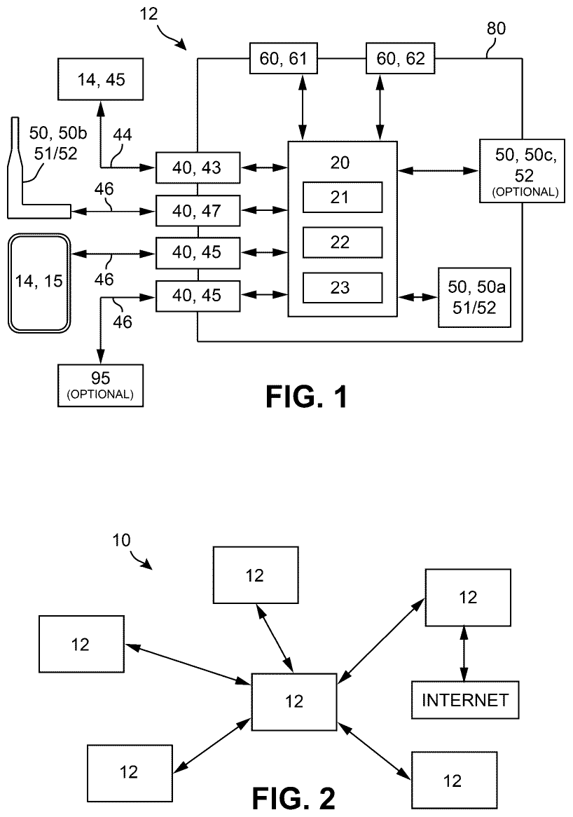

Exemplary combinations of the different communication devices 40, 50 that may be associated with the communication interface 23 of the controller 20 are explained in greater detail hereinafter when describing an embodiment of the hub 12 as shown in FIG. 1.

Each of the hubs 12 may further include at least one user control mechanism 60 in signal communication with the controller 20 thereof. Each of the user control mechanisms 60 may refer to a structure, device, mechanism, push button, slide, knob, dial, lever, sensor, or the like that is able to be interacted with by a user of the hub 12 for communicating information to the controller 20 via a corresponding signal connection, wherein such communication may result in the controller 20 conducting further signal communication with a corresponding one of the A/V devices 14, such as the described mobile device 15. Exemplary user control mechanisms 60 are described hereinafter when describing the specific example of the hub 12 as illustrated in FIG. 1.

Each of the hubs 12 further includes a battery 70 or similar energy-storing device for powering the components of the hub 12, and in some cases, one or more of the external devices, such as the A/V devices 14 that have a direct, docked, or wired connection to the hub 12. The battery 70 is rechargeable and may include one or more rechargeable lithium ion batteries. The battery 70 may be configured to be rechargeable via the connection of an external power source 95 to one of the mechanical communication devices 40 of the hub 12. The battery 70 may be provided to store sufficient energy such that the corresponding hub 12 can be powered for a sufficient period of time following the charging process while also having enough excess energy to optionally power the operation of one or more of the A/V devices 14, including potentially recharging a battery of the associated mobile device 15 when docked with the hub 12. The battery 70 may be utilized to power or recharge any applicable components able to dock with the hub 12 via a corresponding one of the mechanical communication devices 40, and hence may serve the function of a power bank for the user to utilize in charging or powering any of a variety of possible user devices.

Each of the described components may be incorporated into a housing or casing 80 of the hub 12. The casing 80 may include an interior for housing the described electrical components, such as those forming the controller 20 and the battery 70, and may further include various openings or other ports extending to an outer surface thereof for establishing a suitable connection via any of the described external communication devices 40, 50, which may extend to or outside of the outer surface of the casing 80.

The casing 80 may be provided to include a substantially rectangular cuboid shape and may include dimensions similar to that of a paired mobile device 15, wherein the casing 80 may be sized and weighted for manual manipulation or carrying. As one non-limiting example, the casing 80 may be approximately 3.5″×2.5″×0.75″ in dimensions. The casing 80 may include a distribution of the described external communication devices 40, 50 and user control mechanisms 60 to desired surfaces or sides of the casing 80 for facilitating ease of use of the hub 12 and any paired A/V devices 14, as explained in greater detail when describing the exemplary hub 12 of FIG. 1. The casing 80 may be formed from any durable material capable of protecting the internal components of the hub 12, and may be formed from a hard rubberized or plastic material. The material forming the casing 80 should also be waterproof/resistant and able to withstand the types of forces encountered by the hub 12 during use thereof.

The embodiment of the hub 12 as shown in FIG. 1 includes a combination of components and features that provide numerous benefits to the users of the communication system 10. However, it should be readily apparent to one skilled in the art that the features and components described hereinafter may be provided individually and/or in different combinations than those shown and described in FIG. 1 while still appreciating the benefits of such components and features, and hence the illustrated embodiment is not to be considered in any way limiting or restrictive to the present invention. The present invention may be considered to include any combination of the components and features illustrated in FIG. 1, including the omission of any non-critical component or the addition of any number of additional or redundant components mentioned herein, including the use of additional external devices to that shown.

The embodiment of FIG. 1 includes the hub 12 having four of the mechanical communication devices 40 for making four different direct, wired, or docked connections between the hub 12 and one of the A/V devices 14, an external power source 95, or another externally disposed device (not shown) capable of signal communication with the hub 12, such as an external memory device (not shown) configured for mechanical connection to one of the mechanical communication devices 40. In the illustrated embodiment, two of the mechanical communication devices 40 are USB-C ports 45. However, alternative bundled power and communication ports may be utilized while remaining within the scope of the present invention, such as a Micro-HDMI port (HDMI Type-D), as non-limiting additional examples. Each of the illustrated USB-C ports 45 is a female USB-C port configured to receive a mating male USB-C port disposed at an end of an associated USB-C cable or cord 46. Alternatively, it is understood that the USB-C port may be configured to mate or dock directly with an external device in the absence of any form of intervening cord or cable 46 while remaining within the scope of the present invention.

In the provided example, one of the USB-C ports 45 is in signal communication with the mobile device 15 acting as one of the A/V devices 14 and the other of the USB-C ports 45 is in signal communication with the power source 95, which is optionally utilized. The described signal connections may include or correspond to an electrical connection capable of transferring power across a corresponding one of the cords or cables 46 for recharging the battery 70 of the hub 12 via the external power source 95 or across another corresponding one of the cords or cables 46 for charging the mobile device 15 via the battery 70 of the hub 12, as the case may be. The battery 70 may also be utilized to charge any other electrical components described herein that may be able to make such a connection with the hub 12 via one of the corresponding mechanical communication devices 40.

Each of the USB-C ports 45 and corresponding cables 46 may accordingly perform numerous different functions depending on the types of devices or components in communication with the hub 12 and the data transfers being carried out therebetween. In some circumstances, one or more of the USB-C ports 45 may present a generic audio interface that the mobile device 15 can utilize (via cable 46) for the recording and playback of any content that may be generated by use of any of the applications executable via the mobile device 15. The USB-C ports 45 may also be configured to present a network interface for the sending and receiving of data between the hub 12 and the mobile device 15, which in turn facilitates the transfer of data to or from additional ones of the hubs 12 forming the communication system 10. The USB-C ports 45 may alternatively present a control interface (possibly a generic HID device) for low bandwidth control and status information (sending button presses, lighting LEDs, changing network modes, etc.). Each of the USB-C ports 45 may also be utilized for docking a secondary communication component to the hub 12 for communicating data therebetween in similar fashion to the described mobile device 15, such as docking a tactical radio or other military component having networking capabilities associated therewith to the hub 12 for the transfer of data therebetween. Each of the hubs 12 may accordingly act as a bridge for any such secondary components in communicating data among any corresponding ones of the hubs 12 forming the associated communication system 10. Such a process may correspond to a component having networking capabilities via USB or Ethernet-over-USB. The hub 12 is accordingly capable of acting as a bridge for multiple different communication networks simultaneously via connection to multiple different communication devices, such as the mobile device 15 and the above-described secondary communication component. The hub 12 can also utilize an upstream network connection, even where provided by a 3rd party manufacturer, and route data from this upstream network connection to both the mobile device 15 associated with the corresponding hub 12 and all other mobile devices 15 in communication with the corresponding hub 12 via the wireless communication capabilities of the hub 12 as described herein. According to another advantageous feature of the hub 12, the hub 12 may be provided as a form of mass-storage device, and especially with respect to any secondary communication component or mobile device 15 in signal communication with the hub 12 via one of the mechanical communication devices 40, such as one of the described USB-C ports 45. The hub 12 may include a secondary storage device (not shown) integrated therein, such as an integrated Secure Digital (SD) card, that allows for the mass storage capability. The hub 12 may also be in signal communication, via one of the wireless communication devices 50 thereof, with an externally disposed storage device or network to allow for the hub 12 communicating therewith to act as a mass storage device having data accessible to the remainder of the communicating hubs 12 of the communication system 10. The ability to store data via a storage means associated with the hub 12 allows for especially large files (in terms of storage), such as high-resolution map images or the like that are associated with military functions and missions, to be accessible to each mobile device 15 where such files may otherwise not be able to be maintained on the storage device integrated into the associated mobile device 15. Each hub 12 can accordingly have certain data stored to the mass storage device thereof that is then able to be accessible via the associated mobile device 15 whenever access to such data is necessary, and such data can also be forwarded onward to any other associated hubs 12 of the communication system 10.

Different hubs 12 may include different files (data) stored thereto to distribute the storage among the different hubs 12 participating in the communication system 10.

In the illustrated embodiment, one of the mechanical communication devices 40 is an audio jack 43 configured for mating with a cord or cable 44 associated with a headset 45. The headset 45 may include a microphone and speaker combination of any suitable form for carrying out two-way audible communication over the headset 45. The audio jack 43 may be what is referred to as an ODU® connector port that is configured to transfer any of a stereo audio out signal, a mic signal, a push-to-talk signal, and/or electrical energy for powering the associated headset 45, wherein the audio jack 43 may be configured for mating with an end of the corresponding cable 44. As another example, the audio jack 43 may be a TP-120 jack that operates in similar fashion to the described ODU connector. Typically, a military grade headset having one or two audio jacks (called Dual-comm) may be utilized in conjunction with the hub 12. The headset 45 may be a combat-rated PELTOR headset, as one non-limiting example. The headset 45 may also be replaced with an alternative form of radio or other auditory communication device while remaining within the scope of the present invention.

The long-range wireless communication device 51 of the illustrated embodiment may be associated with at least one antenna acting as a transmitter/receiver/transceiver with respect to at least one radio frequency (RF) signal generally associated with generating a Wi-Fi signal, thereby allowing for each of the hubs 12 to form a wireless access point (WAP) via use of the long-range wireless communication device 51. The at least one antenna may be configured to transmit/receive signals from a 2.4 GHz frequency or 5.0 GHz frequency, as non-limiting examples. The at least one antenna may be externally disposed or otherwise protruding from the casing 80 in order to improve signal strength in comparison to the antenna of a device such as the connected mobile device 15. Additionally, the at least one antenna may include greater power requirements than a corresponding antenna of the mobile device 15 in order to facilitate the generation of the desired signal strength when broadcasting via the long-range wireless communication device 51. The at least one antenna associated with the long-range wireless communication device 51 may accordingly have a greater range and more available bandwidth than would a comparable RF antenna of the associated mobile device 15. The addition of an improved RF antenna to the hub 12 also presents the ability for the user to utilize such an RF antenna of the mobile device 15 as a supplemental communication device for performing relatively shorter range tasks, including when certain local communication features of the mobile device 15 are accessed that generally do not relate to operation of the hub 12. The use of Wi-Fi as a communication method is also preferable over the use of typical military (CB) radios due to the much lower power (range) and higher frequencies at which the Wi-Fi signals are broadcast.

The hub 12 shown in the embodiment of FIG. 1 includes two different examples of the antennas in the form of an integrated antenna 50a and an external antenna 50b, each of which are identified as potentially forming either or both of the long-range and short-range wireless communication devices 51, 52, depending on the circumstances and/or system configuration of the hub 12. The integrated antenna 50a may refer to an internally disclosed or outwardly protruding antenna that is integrated into the structure of the hub 12 (and casing 80 thereof) to always be accessible during use of the hub 12. In contrast, the external antenna 50b may be provided as a secondary component that removably docks with the hub 12 via one of the mechanical communication devices 40 such that the external antenna 50b is only available for use with the hub 12 when docked thereto. The integrated antenna 50a and the external antenna 50b may vary in characteristics from one another, and may thus in some embodiments form the respective long-range and short-range wireless communication devices 51, 52. In other embodiments, each of the antennas 50a, 50b are operable to act as only one of the long-range or short-range wireless communication devices 51, 52, wherein the different antennas 50a, 50b may be utilized for differing applications while performing the corresponding long-range or short-range communication related processes, as the case may be, that are associated with the operation of the hub 12. The external antenna 50b is shown as being docked to the hub 12 via a corresponding cord or cable 46, but the external antenna 50b may alternatively be docked directly to the hub 12 via a direct connection to one of the mechanical communication devices 40. The external antenna 50b may be configured to dock with the hub 12 via a corresponding SubMiniature version A (SMA) port 47 acting as one of the mechanical communication devices 40, as one non-limiting example. Where multiple antennas are utilized, such as the disclosed combination of the integrated and external antennas 50a, 50b, the controller 20 may be associated with an RF multiplexer configured to switch between operation of the two different antennas.

The embodiment shown in FIG. 1 includes one form of the short-range wireless communication device 52 provided as an Infrared (IR) transmitter/receiver/transceiver 50c configured to send/receive data that is broadcast at an IR wavelength, and may further utilize bidirectional IR. The IR transceiver 50c may include a broadcast range that is significantly smaller than that of the antenna associated with the long-range wireless communication device 51, thereby rendering it difficult for such communications to be intercepted or otherwise detected by a third party, such as an enemy combatant or the like. The short-range wireless communication device 52 acting as the IR transceiver 50c may accordingly be utilized in those circumstances wherein communication using an RF broadcast is considered to be problematic or otherwise undesirable, such as when especially sensitive information is being transferred such as a mission secret or an electronic encryption key, as non-limiting examples. However, as explained above, in some circumstances the long-range and short-range communication methods may each include the use of an RF broadcast, but with differing characteristics for carrying out the desired communication process, such as reducing or increasing a broadcast range thereof for changing the corresponding wireless communication device 50 between the long-range and short-range wireless communication devices 51, 52 in accordance with the present disclosure.

The IR transceiver 50c as described may accordingly be considered optional for use with the hub 12 depending on the remaining wireless communications devices 50 associated with the hub 12, such as whether the hub 12 is utilizing the integrated and external antennas 50a, 50b in combination in forming the long-range and short-range communication devices 51, 52.

The IR transceiver 50c may include at least one sensor (not shown) for detecting an IR broadcast from another one of the hubs 12 in close proximity thereto. The at least one sensor must accordingly be outwardly disposed relative to the casing 80 to provide a line of sight for the sensor to receive the IR broadcast from another one of the hubs 12. Such a sensor may accordingly be disposed on an exposed surface of the casing 80, and preferably a forward facing surface of the casing 80 when the mobile device 15 and/or the hub 12 is being operated. In some embodiments, the IR sensor is mounted to the casing 80 to always be exposed or forward facing, such as placing the IR sensor on a forward facing surface of the hub 12 when the hub 12 is attached to a chest area of the user to facilitate the IR sensor facing outwardly towards another one of the short-range wireless communication devices 52. In some embodiments, the IR sensor may only be outwardly or forwardly facing following a manipulation of the mobile device 15, the hub 12, or some structure or mechanism associated with the hub 12. For example, the hub 12 may be rotatably or hingedly coupled to the mobile device 15 such that relative pivoting between the hub 12 and the mobile device 15 may reposition the IR sensor of the hub 12 for facing towards another wireless communication device 52 or may uncover the IR sensor from a position previously covered by the mobile device 15. The hub 12 may also include two or more of the IR sensors to allow for detection in multiple directions or under multiple different circumstances.

However, any structural configuration allowing for the IR sensor to detect an IR signal from another one of the hubs 12 may be utilized without necessarily departing from the scope of the present invention. The IR sensor may preferably have a detection range wherein data can only be transmitted when at close proximity to another of the hubs 12, such as within several feet of each other.

The wireless communication devices 50 provided as the integrated or external antennas 50a, 50b have been described thus far as utilizing an RF signal generally associated with generating a Wi-Fi signal, thereby allowing for each of the hubs 12 to form a wireless access point (WAP) via use of the corresponding long-range wireless communication device 51. However, the present invention is not limited to the use of Wi-Fi, and may instead utilize a mobile ad hoc network (MANET) based approach, such as utilizing a MANET radio utilizing a mesh topology instead of the star topology associated with Wi-Fi. The use of a MANET provides the same functions as described with regards to Wi-Fi, but may allow for a network that covers much longer ranges, such as 5 km or greater. The MANET capability may be associated with a chip integrated into the structure of the hub 12, such as being internally disposed within the casing 80. Such a MANET chip may be configured to allow for broadcasting via adjustable power (range) and frequency, thereby facilitating the ability of the MANET enabled communication method to adjust to various conditions. As one example, such a MANET capability may facilitate the ability to adjust a frequency at which a broadcast is occurring when it is determined that the instantaneously utilized frequency is congested and/or jammed. As another example, such a MANET capability may facilitate an adjustment of the MANET associated wireless communication device 50 between the long-range and short-range wireless communication devices 51, 52 based on the selected power/frequency to which the MANET associated wireless communication device 50 is adjusted.

According to one aspect of the present invention, one or both of the long-range and short-range wireless communication devices 51, 52 may include the ability to automatically change the frequency of the RF signal utilized in communicating between the different hubs 12 when it is determined that the currently utilized frequency is congested and/or jammed. That is, each of the hubs 12 may be configured to automatically adjust the communication frequency utilized as such congestion or jamming becomes evident, thereby allowing for a seamless transition when the ability to communicate clearly is otherwise compromised.

The hub 12 of the illustrated embodiment includes two of the user control mechanisms 60 including a push button 61 and a power adjustment switch 62. The push button 61 may be any depressible or otherwise actuated structure that can be manually manipulated by a user of the hub 12 for making a signal connection with the controller 20 of the hub 12, which can in turn utilize this signal connection as a trigger to perform other tasks such as passing along the data associated with the actuation of the push button 61 to other hubs 12 or external devices in signal communication with the hub 12. For example, the controller 20 may be configured to recognize different push combinations or durations as being associated with different control commands, such as the need to broadcast a message via the hub 12. Such push combinations may include a single rapid push, multiple successive rapid pushes, one or more held pushes of longer duration, and combinations thereof, for communicating any desired information. Possible beneficial uses for the push button 61 are described hereinafter when describing the possible applications of the hub 12 and communication system 10.

The power adjustment switch 62 may be provided as a hardware kill switch for all RF transmissions originating from one or more of the wireless communication devices 50, and especially the described long-range wireless communication device 51 acting as a WAP for the hub 12. This mechanical kill switch, which may be provided as a rotatable control, slide control, or other adjustable control, is configured to cease all RF communication when activated, as may be required when signal detection is no longer desired. Although the power adjustment switch 62 is shown as being incorporated into the structure of the casing 80 in FIGS. 4-6, in other embodiments the power adjustment switch 62 may be a feature integrated into an application or plug-in executed on the mobile device 15, such as having a slide-control accessible via touch interaction with the screen of the mobile device 15. The power adjustment switch 62 may accordingly be optionally provided within the casing 80, hence the present invention is not limited to the configuration shown throughout FIGS. 4-6.

The casing 80 may include any configuration suitable for providing access to each of the disclosed features of the hub 12 in the manner described. Components such as the mechanical communications devices 40 may be distributed about an outer surface of the casing 80 to facilitate ease of use when the hub 12 is mounted to a user, such as when mounted to a chest area of the user. The casing 80 may include a rear surface configured to optionally face towards the chest of the user when mounted thereto, and the remaining features may be formed on a front surface or any of the four remaining side surfaces of the casing 80. In one preferred configuration shown in FIGS. 4-6, features such as the mechanical communication devices 40 are disposed on the left and right lateral sides of the hub 12 (when mounted to a user) while features such as the user control mechanisms 60 may be disposed on a front or top surface of the casing 80. Specifically, the disclosed casing 80 includes two of the USB-C ports 45 disposed on a first lateral side of the casing 80, the audio jack 43 and the SMA port 47 disposed on an opposing second lateral side of the casing 80, and the user control mechanisms 60 provided on the top surface of the casing 80. However, alternative configurations may be utilized from that shown and described while remaining within the scope of the present invention.

The mobile device 15 utilized in conjunction with the hub 12 may include one or more software applications stored thereto or otherwise accessible by the mobile device 15 that are configured for use with the hubs 12 and the communication system 10. Such a software application may include various features related to the sharing of data between multiple different user devices in signal communication with the communication system 10, as well as the ability to display or playback any audiovisual data accessible by the mobile device 15. As such, each of the mobile devices 15 associated with the communications system 10 may preferably include at least one common software application configured to send/receive and/or play/display audiovisual data that may be shared between the different hubs 12. Such a common software application may be considered a data sharing application.

It should be understood that the communication system 10 allows for each of the mobile devices 15 to include common data stored thereto that can be accessed during use of the communication system 10. For example, each mobile device 15 associated with the communication system 10 may download the necessary data related to a specific mission or other common task prior to initiation thereof, wherein this common data may be referenced by each of the hubs 12 during communication between the hubs 12 and the corresponding mobile devices 15.

In one embodiment, each of the mobile devices 15 associated with the communication system 10 is an Android Samsung S20 having software that is known as the Android Team Awareness Kit (ATAK) software stored thereto and executable thereon. A mobile device 15 having the ATAK software may alternatively be referred to herein as an ATAK device. The ATAK software may offer various data sharing features that can be utilized by the hub 12 for communicating between multiple different mobile devices 15, and may include various display interfaces for interacting with the user and displaying or playing back audiovisual content. The hub 12 may be operable with the ATAK software via the introduction of a plug-in to the ATAK software especially suited for executing the specific tasks described hereinafter as being unique to the communication system 10.

As used hereinafter, the software application (or applications) utilized by the mobile device 15 when performing the tasks of the communication system 10 is referred to as the mobile software application, which may refer to the described ATAK software or a modification thereof. The mobile software application may be configured to store certain data to the memory device of the mobile device 15 for later transmission to another of the hubs 12, as described hereinafter. The mobile software application is also generally configured to cause the display of visual date or the audible playing of audio data via any of the devices connected to the hub 12, including the mobile device 15 itself, or another device such as the headset 45. The mobile software application is described in further detail hereinafter when describing the various different tasks that can be performed using the communication system 10.

Referring now to FIG. 2, a general overview of the manner of use of the communication system 10 is described. The communication system 10 may include a plurality of the hubs 12, each of which is associated with a respective mobile device 15, that are each in signal communication with one another via the long-range wireless communication device 51 of each of the respective hubs 12. That is, any one of the hubs 12 of the communication system 10 may form a WAP via the broadcast of a corresponding RF signal. The mobile software application may allow for the hub 12 operating as the WAP to utilize the connected mobile device 15 for establishing a name of the WAP and any other credential verifying information needed to connect to the WAP.

The hub 12 establishing the WAP may then act as a centralized hub 12 through which the communications of the other hubs 12 are routed when communicating over the communication system 10. Specifically, the hub 12 acting as the WAP may act as an intermediary hub 12 for receiving transmissions from each of the participating hubs 12 and sending transmissions to each of the participating hubs 12, hence some or all of the inter-hub communication may be conducted through the hub 12 established as the WAP.

However, the communication system 10 is not limited to the signal communication configuration shown in FIG. 2. Instead, the communication system 10 may utilize any order and configuration of communications between the different hubs 12 as may be applicable, so long as the data is transferred to the same hubs 12 in accordance with the desired network configuration. For example, any number of different connections may be established between different pairings of the hubs 12, such as the use of multiple different WAPs distributed among multiple different hubs 12, for communicating the data from one hub 12 to another, as opposed to using a centralized hub 12 for managing the WAP among the group of hubs 12 where all data passes through the centralized hub 12. The communication system 10 may include any combination of wireless data transfers between the different hubs 12 that are within signal range of one another while remaining within the scope of the present invention. The communication system 10 may be further configured wherein a broadcast range of the system 10 is increased by utilizing the different hubs 12 within range of each other as signal boosters or range extenders. In other words, any of the hubs 12 may act as an intermediary hub 12 with respect to any of the other hubs 12 within broadcast range thereof, hence any hub 12 within broadcast range of at least one of the other hubs 12 may be able to communicate with the remaining hubs 12 of the communication system 10 via the appropriate number of data transfers.

The data transfers described herein may relate to data of any form, type, or protocol. As mentioned above, such data may typically be related to visual data or auditory data. The visual data may refer to images or videos that may be able to be accessible via the display screen of the mobile device 15 of each of the hubs 12, while the auditory data may refer to the sound files or audio feed that may be accessible via a speaker (headphones) of the mobile device 15 or the headset 45, as non-limiting examples. The present invention may include any form of data originating from any of the external devices 14 in signal communication with one of the hubs 12 or one of the user control mechanisms 60 of the associated one of the hubs 12 being able to be communicated to another one of the hubs 12 for further signal communication to the external devices 14 of those hubs 12, wherein all appropriate data conversions and manipulations are assumed to occur for rendering such data as applicable to such devices 12. 14. For example, an audio feed originating from the headset 45 of a first hub 12 may be transferred to the directly connected first hub 12, forwarded to another second hub 12, and then forwarded to the headset 45 directed connected to the second hub 12. As another example, an audio recording may be desired wherein audio originating from the headset 45 of the first hub 12 is transferred to the first hub 12, then transferred to the mobile device 15 for storage via execution of a feature of the mobile software application, which in turn initiates a transfer of the audio recording to the second hub 12. The second hub 12 may then transfer such data to the mobile device 15 thereof for causing the playback of the recording via a feature of the mobile software application, which may include the audio recording being transferred to the headset 45 of the second hub 12 or may include the recording being played or interacted with directly on the mobile device 15. Any command originating from a user control mechanism 60 such as the push button 61 may also be communicated to any of the other hubs 12 for further communication to any of the associated devices 14.

The manner of operation of the communication system 10 also facilitates the ability to utilize one of the hubs 12 for access to an external network or remote server, which can then be used according to the methods described above for communicating such data to any combination of the hubs 12 within range of the combined system 10. For example, one of the hubs 12 may be able to establish a hardline internet connection, and this hub 12 may then act as a centralized hub 12 for communicating with all other participating hubs 12 such that all of the participating hubs 12 may have some form of access to the internet, or other network connection, via this hardline connection. A similar circumstance may be found when one of the hubs 12 or associated mobile devices 15 is able to establish wireless internet access, such as may occur via satellite linkage or cellular service access for one of the hubs 12. That is, one of the hubs 12 may act as the centralized hub that is in communication with a desired network, such as a network associated with a military headquarters or the like, via corresponding satellite-based or cellular-based communications associated with a component of the hub 12 or a secondary component docked to the hub 12. One or more of the hubs 12 may also be associated with some form of server or memory bank utilized to store or manage various communications or other data between the hubs 12, wherein access to this server may be shared among the hubs 12 via the same processes described above.

FIG. 2 illustrates an example where one of the non-centralized hubs 12 establishes an internet connection. The hub 12 having the internet connection may then communicate with the centralized hub 12, which then communicates with all remaining hubs 12. All hubs 12 in signal communication with the centralized hub 12 may then have some form of access to the internet via the appropriate transfers between the centralized hub 12, the hub 12 connected to the internet, and the hubs 12 connected to the centralized hub 12.

The communication system 10 as described may be utilized for multiple different applications and processes, several examples of which are elaborated on hereinafter. However, it should be readily apparent that the features as implemented in these examples are non-limiting to the present invention.

As mentioned throughout, the communication system 10 may be utilized for the sharing of audiovisual data as may be displayed or played back via one of the A/V devices 14.

Such a feature may be utilized in carrying out military objectives. For example, before combat in environments where audio quality is paramount and limited range is acceptable, the communication hub 12 on each person can be used for briefing purposes, screen sharing, or video sharing while communicating via half-duplex style audio (full duplex telephony is also possible as an alternate feature according to some embodiments). Shared screens, which refers to the sharing of the data displayed on each of the mobile devices 15, can have markup capabilities as facilitated by the mobile software application. That is, any user of one of the hubs 12 may interact with the shared screen image for forwarding an edited screen image to another user of one of the hubs 12, such as marking up or otherwise annotating a map, image of a target, or the like when a particular route, target, or the like is desired.

As another specific example, the mobile software application may include a voicemail feature wherein an auditory message generated via the use of one of the hubs 12 is forwarded to each of the participating hubs 12 for storage to the mobile device 15 thereof. The user can access the mobile device 15 and then choose to listen to the auditory message at a desired time based on selection of the file in question. Users may accordingly listen to important messages whenever the opportunity presents itself, rather than being unaware of messages that were not heard or were otherwise missed or unintelligible in real time.

The mobile software application may also include a group management feature for determining which of the hubs 12 should be participating in certain communications with certain others of the hubs 12. For example, a direct message feature may be available where communications are present only between a first user and a second user associated with respective hubs 12, wherein any data can be shared therebetween and in the absence of other users and hubs 12 not associated with the direct messaging session. The same feature may support the generation of certain groups of users, which would correspond to certain groups or subsets of the hubs 12 forming the communication system 10, that can participate in a data sharing session such as a group chat or video conference, group shared screen session, or the like.

The mobile software application may also be configured to include a data forwarding feature wherein certain data is forwarded from one hub 12 to another whenever a suitable wireless connection is made therewith, thereby allowing for certain data to reach a destination as soon as possible. For example, one or more of the hubs 12 forming a chain of communication among the hubs 12 may be unable to connect to the local area network established by the WAP, or may otherwise be unable to transmit data with another one of the hubs 12, such as may occur when one of the hubs 12 is abandoned or damaged (as may occur during battle). The data transferred to that hub 12 may be stored to the memory device of the mobile device 15 with the mobile software application configured to forward the data onward to the next of the hubs 12 in the chain of communication when a suitable connection is established for completing such a data transfer, such as a reconnection to the local area network. As another example, one of the hubs 12 may require access to a hardline or other network connection, such as access to the internet, to complete the desired communication, such as when relaying information to a remote base or entity. The corresponding mobile device 15 may store this data and then initiate a transfer upon determination that such a connection has been made.

The described feature may be utilized for certain emergency messages of urgency wherein it is important that such information is forwarded at the earliest possible circumstances, such as when a medical emergency has occurred. In this way, one of the users of one of the hubs 12 may record a message, such as a recording regarding the emergency, which can be stored to each successive mobile device 15 of each successive hub 12 until the necessary connection has been made to complete the transmission to the final destination, such as a military base or entity. This feature can also be utilized to periodically, when possible, update the final destination regarding other data relevant to the mission such as GPS location, waypoints, etc.

As mentioned previously, the user control mechanisms 60 may be utilized for controlling certain aspects of the operation of the corresponding hub 12. In some embodiments, the push button 61, which may be provided to have a click-like mechanism for making depression of the push button unambiguous, enables certain forms of communication when pressed in a certain pattern, such as a single press, multiple rapid presses, a held press, etc. As one example, a single press would be for starting audio communication, two rapid presses for audio hold, and three rapid presses for beginning recording an emergency message (as explained above) that can be sent and recalled later. The pressing pattern can be linked to any process provided by the hub 12. It should also be readily apparent that alternative structures, such as dials, slide mechanisms, or the like, may similarly be adjustable or actuatable for performing these same types of functions according to any interaction pattern or adjustable configuration.

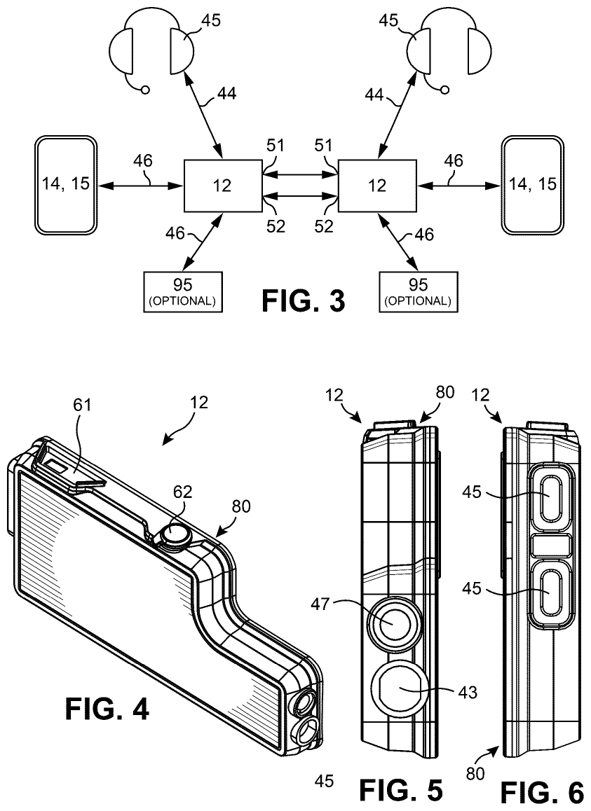

Referring now to FIG. 3, a method of utilizing the long-range wireless communication device 51 and the short-range wireless communication device 52 in conjunction is disclosed. A first hub 12 is shown as being in communication with a second hub 12 via each of the disclosed wireless communication devices 51, 52. The long-range wireless communication device 51 utilizes the described RF signal communication as a primary means of communication between the first hub 12 and the second hub 12 according to the data sharing processes described herein, as well as any other hubs 12 in range of the communication system 10. The short-range wireless communication device 52 forms a secondary or supplemental means of communication between the first hub 12 and the second hub 12, which may be necessary to account for certain circumstances. The secondary means of communication may be selected to utilize a lower bandwidth, a more secure transmission, and a shorter transmission range, or any combination thereof. The secondary means of communication may be the described IR transceiver 50c, as one non-limiting example, one of the described antennas 50a, 50b. Alternative communication methods may include an audio/speaker code between two different devices, a front facing camera for sensing an image, or a direct wired connection such as one of the described USB connections. Other short range communication techniques may include Bluetooth or NFC, as non-limiting examples.

The secondary means of communication provided by the short-range wireless communication device 52 may include the transfer of a key or other data relating to a shared secret of some form to be utilized by the participating hubs 12 forming the communication system 10. Such a key may relate to some form of encryption or network security applied when transferring data via the long-range wireless communication device 51. One example may occur when a soldier joins an existing group that is utilizing a shared key. The short-range wireless communication device 52 may be utilized to transfer data regarding the key when the two associated hubs 12 are disposed in close proximity to each other for detection by the corresponding IR sensors or other close range sensors. The key may be used by the hub 12 of the joining soldier to attain credentials for joining a WAP established by one of the hubs 12 via the long-range wireless communication device 51.

While the above detailed description focuses primarily on military use cases for embodiments of the invention, embodiments of the invention are likewise well-suited for non-military use cases, especially those involving group activities. For example, group activities in loud ambient environments including but not limited to gyms and physical training activities, guided tours in museums and/or cities, at the home, with kids enjoying media (without creating extra noise), and educational uses such as group learning exercises in the classroom.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A mobile communication hub comprising:
a controller in signal communication with each of:
a first mechanical communication device establishing a direct wired connection with a mobile device having a display screen;
a first wireless communication device configured to utilize a first wireless communication process;
a second wireless communication device configured to utilize a second wireless communication process different from the first wireless communication process.

2. The mobile communication hub of claim 1, wherein the first wireless communication process includes the use of a radio frequency (RF) signal.

3. The mobile communication hub of claim 1, wherein the first wireless communication process includes the creation of a local area network using a wireless access point (WAP).

4. The mobile communication hub of claim 1, further comprising a second mechanical communication device establishing a direct wired connection with a headset having a microphone and a speaker.

5. The mobile communication hub of claim 1, wherein the first wireless communication process includes a greater broadcast range than the second wireless communication process.

6. The mobile communication hub of claim 1, wherein the first wireless communication process utilizes a first electromagnetic wavelength and the second wireless communication process utilizes a second electromagnetic wavelength.

7. The mobile communication hub of claim 1, wherein the second wireless communication process is utilized to transfer a shared secret utilized by the first wireless communication process.

8. The mobile communication hub of claim 1, further comprising a rechargeable battery that is rechargeable via use of a second mechanical communication device.

9. (canceled)

10. The mobile communication hub of claim 1, further comprising a rechargeable battery and wherein a battery of the mobile device is configured to be chargeable via the rechargeable battery of the mobile communication hub.

11. The mobile communication hub of claim 1, further comprising a casing for housing the controller, the casing comprising a button disposed at an outer surface of the casing, the button in signal communication with the controller.

12. (canceled)

13. The mobile communication hub of claim 11, further comprising a switch disposed at the outer surface of the casing, the switch being adjustable to discontinue operation of the first wireless communication device to cease the first wireless communication process.

14. A communication system including a plurality of the mobile communication hubs of claim 1, wherein each of the mobile communication hubs is configured to communicate with at least one of the other mobile communication hubs via one of the first wireless communication process or the second wireless communication process.

15. The communication system of claim 14, wherein the first wireless communication process is utilized to transmit an image or video to the display screen of at least one of the mobile devices associated with one of the mobile communication hubs.

16. The communication system of claim 14, wherein the first wireless communication process is utilized to transmit an audio file to at least one of the mobile devices associated with one of the mobile communication hubs.

17. The communication system of claim 14, wherein one of the mobile communication hubs establishes a local area network to which the remaining mobile communication hubs connect via the first wireless communication process.

18. The communication system of claim 14, wherein the second wireless communication process is utilized to transmit a shared secret to at least one of the mobile devices associated with one of the mobile communication hubs.

19. The communication system of claim 18, wherein the shared secret relates to gaining permission to utilize the first wireless communication process.

20. The communication system of claim 18, wherein the shared secret is transmitted prior to the transmission of data using the first wireless communication process.

21. A method, comprising:
utilizing a first short-range wireless communication device of a first mobile communication hub and a second short-range wireless communication device of a second mobile communication hub to transfer of a key to a shared secret, the transfer of the key to a wireless access point (WAP) of at least one of the first mobile communication hub and the second mobile communication hub facilitating providing credentials for joining a communication between a first long-range wireless communication device of the first mobile communication hub and a second long-range wireless communication device of the second mobile communication hub; and
communicating, via a RF signal and based on the user providing the credentials for joining the communication, between the first long-range wireless communication device of the first mobile communication hub and the second long-range wireless communication device of the second mobile communication hub.

22. The method of claim 21, wherein the transfer of the key incorporates a supplemental communication that has a lower bandwidth than the RF signal and that has a shorter transmission range than the RF signal.
